(19) United States
(12) Patent Application Publication
(10) Pub. No.: US 2023/0180766 A1
(43) Pub. Date: Jun. 15, 2023

(54) ANTIMICROBIAL MULTILAYER STRETCH-WRAP AND METHOD TO PRODUCE THE SAME

(71) Applicant: Zeev SAPIR, Kfar Tavor (IL)

(72) Inventor: Zeev SAPIR, Kfar Tavor (IL)

(21) Appl. No.: 17/920,882

(22) PCT Filed: Apr. 18, 2021
(86) PCT No.: PCT/IL2021/050435

§ 371 Date: Oct. 24, 2022

(30) Foreign Application Priority Data
Apr. 27, 2020 (IL) 274303

(51) Int. Cl. A01N 59/18; A01N 25/34; A01N 59/16; B32B 7/02

(52) U.S. Cl. CPC A01N 59/18; A01N 25/34; A01N 59/16; B32B 7/02; B32B 27/08

(57) ABSTRACT

A multilayer antimicrobial stretch plastic wrap, comprising at least three layers, wherein at least one layers comprising multiple metal compound particles integrated into said layer material, and wherein said at least one layer is not the central layer of the wrap and wherein, said at least one layer is proximal to an outer surface of the wrap than to the center of the wrap.

### FIELD OF INVENTION

The present invention is in the field of plastic films for packaging, and specifically, stretch wraps, and even more specifically multilayer stretch wraps.

### BACKGROUND

The use of metal compounds such as copper, silver, and zinc as an antimicrobial agent is well known throughout history.

Such use of metal compound particles is known to be used in the fields of food protection and home and domestic cling films.

Some food preservative films make use of copper or other metals in order to enhance the effect of other antibacterial agents. Such a method is described in CN208006402U, a utility model that discloses a modified antimicrobial preservative film. The film in this utility model is a one layer plastic film, covered on both surfaces by a layer of metal topped with a layer of another antibacterial agent (chitosan). The metal layer is not integrated into the film and not presented as particles but rather as a thin covering layer of metal CN101717541 relates to a moisture-preserving and antibacterial preservative film and a preparation method thereof. The moisture-preserving and antibacterial preservative film comprises the following components by weight percent: 70-90 percent of polyethylene or polyvinylidene chloride, 10-30 percent of chitosan, a copper compound which accounts for 0.5-5 percent of the total mass of the polyethylene or the polyvinylidene chloride and the chitosan, and a surface modifier which accounts for 0.1-0.5 percent of the total mass of the polyethylene or the polyvinylidene chloride and the chitosan. The preparation method comprises the following steps of: mixing the copper compound and the surface modifier according to the proportion, drying, carrying out surface treatment, adding the polyethylene or the polyvinylidene chloride and the chitosan, according to the proportion, mixing, and preparing the moisture-preserving and antibacterial preservative film by adopting a one-step film-blowing method.

This patent demonstrates the tendency in the art to use metal as a secondary antimicrobial agent in addition to a primary one, such as chitosan, and to use it in a substantial ratio, in this case 0.5-5% of the total mass of the film.

The motivation of the inventors in said examples is to preserve foodstuffs through enhancing the activity of antibacterial agents such as chitosan, by adding copper-based particles to an inner layer of a film. The films described, although possibly suitable for domestic food preservation, would not be suitable for heavy-duty industrial tertiary packaging.

Other publications show the attempts made in the art to use copper compounds in bioriented films and other non-stretchable plastics.

US2007021528 depicts an antimicrobial additive composition that economically and efficiently imparts antimicrobial characteristics to acrylic polymers and particularly thermoformable, acrylic sheets made from such polymers. The antimicrobial composition comprises an alkyl dimethyl ammonium saccharinate, an oxathiazine, an azole, an isothiazolinone, chlorothalonil, or mixtures thereof, among others.

US2011081530 describes a biaxially oriented antirnicrobial polymeric non-stretchable film comprising coextruding a polymeric substrate layer comprising a first layer of a first polymeric material and a second layer of a second polymeric material wherein the crystalline melting temperature (TM2) of said second polymeric material is lower than the crystalline melting temperature (TM1) of the first polymeric material; stretching the coextruded substrate in a first direction; optionally stretching the substrate layer in a second, orthogonal direction; disposing on the surface of the polymeric second layer a composition comprising a particulate antimicrobial compound and a liquid vehicle, and preferably also a surfactant; and heat-setting the stretched film at a temperature above the crystalline melting temperature (TM2) of the second polymeric material but below the crystalline melting temperature (TM1) of the first polymeric material; wherein the composition is applied to the polymeric second layer after the coextrusion step but before the heat-setting step; such that in the final film said second layer comprises said antimicrobial compound in an amount of from about 1 to about 80% by weight of said polymeric material of the second layer is described. Antimicrobial films are also described. With antibacterial properties given by coating the surface of the film.

It is clearly shown that this patent uses a method that wouldn't allow a further stretch of the final product in the course of post-production usage and, therefore, couldn't be applied to stretch wrap.

EP1509084 discloses polypropylene-based biaxially oriented non-stretchable antimicrobial and antifogging polymeric films useful for food, medicine, and agriculture applications as well as other packaging applications.

All cited publications are related to the preparation and use of various antimicrobial polymer materials, including non-oriented and non-multilayered polymer films, as well as bioriented non-stretchable multilayer polymer films, sheet, etc. containing bioactive metal ions.

Since multilayer stretch wraps for tertiary packaging must hold in place heavy loads even after significant stretching, they are made from high mechanical properties linear ar polyethylenes to allow high stretching percentage and minimal loss of strength after stretching despite the lower thickness of the stretched film.

It will be further noticed that all known publications specifically avoid locating metal compound particles on an outer layer of a film either because of toxicity or because said particles are believed to be disengaged by stretching this result in need for combining other antimicrobial agent and/or using large amounts of metal compounds.

There is still need in the art for a multilayer stretch wrap that allows a cost-effective combination of required physical properties along with antimicrobial activity based on metal ions.

### SUMMARY OF THE INVENTION

The present invention discloses an antimicrobial stretch wrap, containing metal compound particles in one or more of its external layers.

The multilayer stretch wrap could be manufactured in blown, cast, or other known plastic film manufacturing techniques.

The polymer granules are processed in accordance with the standard specification of each specific application of the final stretch wrap product. Nano-sized metal compound particles are mixed into at least one of the two outer layers of the film prior to the extrusion of the film.

When the wrap is stretched as part of its application, the layers become thinner, and the metal compound particles are pushed closer to the surface of the stretched wrap, thus covering a greater area as well as allowing a better impact of their ion action.

The integration of the metal compound particles in the vicinity to the surface of the wrap, combined with the nature of the wrap to be stretched upon usage, result in a more efficient antimicrobial activity using a relatively small amount of metal.

### A DESCRIPTION OF THE DRAWINGS

FIG. 1 shows an enlarged cross-section of a post-production pre-use stretch wrap according to some embodiments of the present invention.

The stretch wrap (100) having two outer surfaces (10) and comprising two outer layers (11) and three inner layers (12).

The metal compound particles (13) are integrated into the upper outer layer.

FIG. 2 is an enlarged cross-section of the post-use stretched film of FIG. 1.

The film (100) is stretched, and therefore the layers (11/12) are longer and thinner. The metal compound particles (13) are closer to the outer surface (10). Some of them are still covered but are located in the vicinity of the surface (10), while the others are not fully covered. A higher percentage of particles are now close to the surface, leading to increased antibacterial activity.

FIG. 3a-f are microscopic images of the surface of a stretch film according to the present invention.

FIG. 3a depicts an overall top look on the outer surface of the wrap.

FIG. 3b depicts the surface of the wrap in a post-production pre-application state, i.e., not stretched. It shows the metal compound particles in the outer layer. FIG. 3c is of the same surface focus on one of said particles.

FIG. 3d-e depict the surface of the wrap after stretching to 250% of its post-production length, similar to a stretch performed in the application of a wrap. The surface has microscopic tears that allow the metal compound particles to pop out above the surface and enhance their activity.

FIG. 3f is the stretched wrap of FIG. 3d-e, in a cross angle, showing the exact direction of the tears, which matches the direction of the stretching.

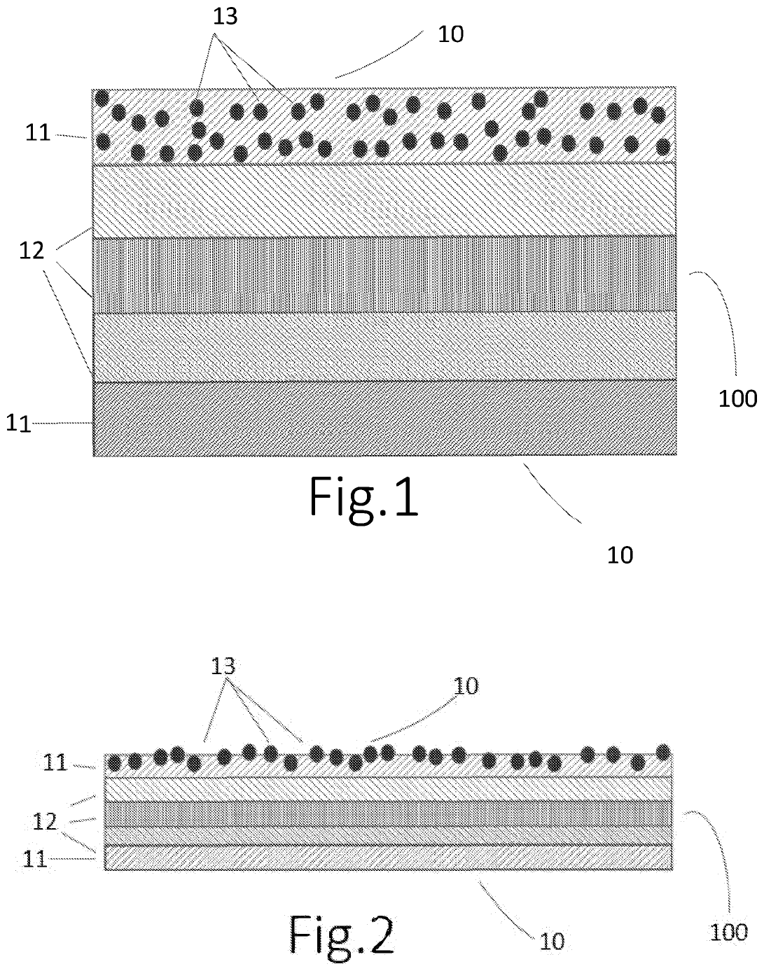

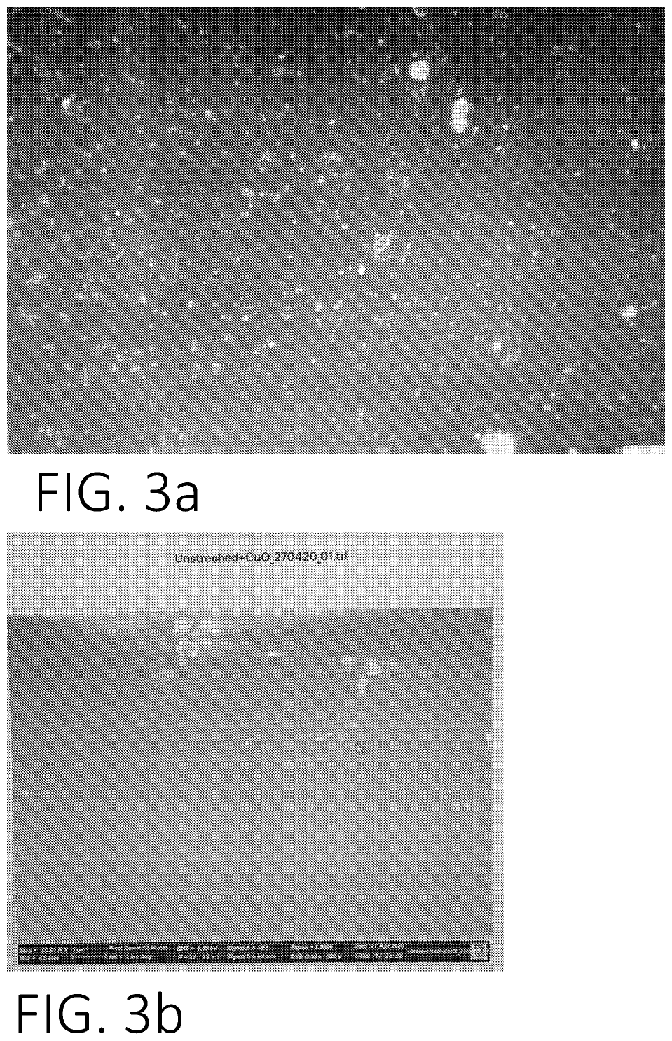

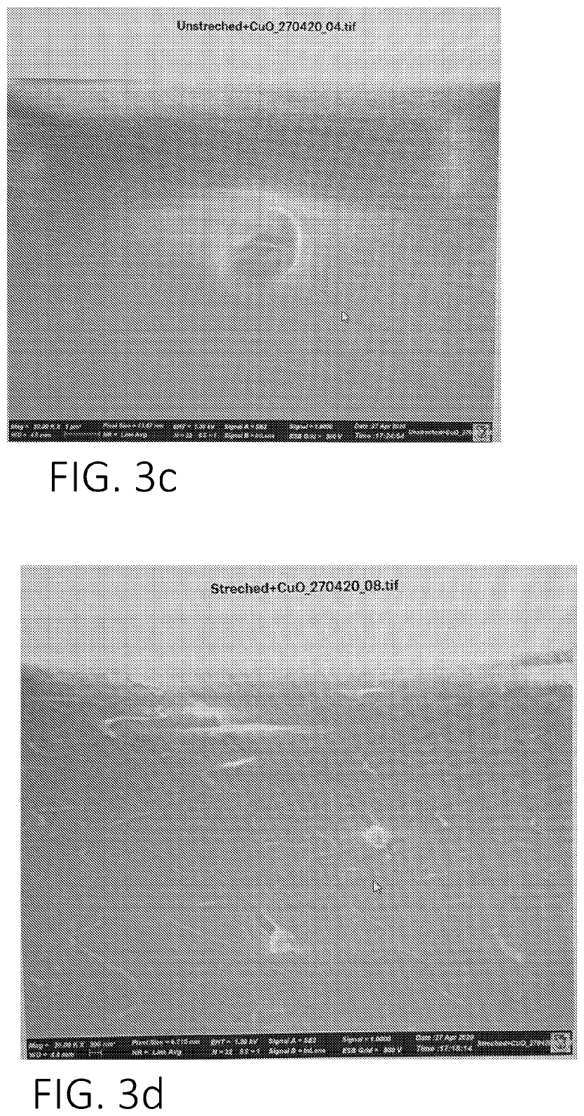

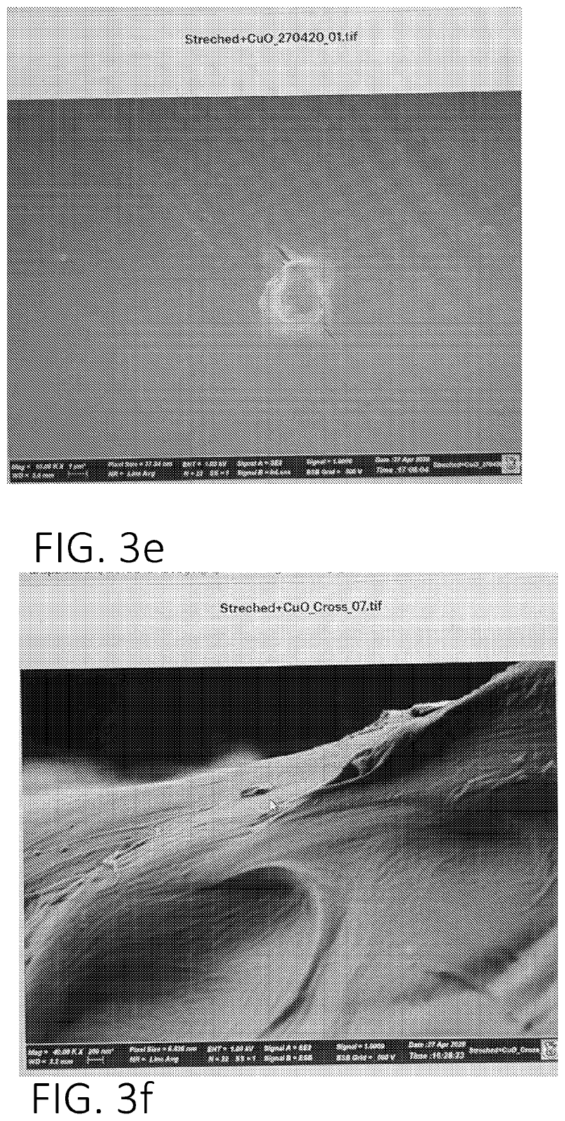

### A DETAILED DESCRIPTION OF THE INVENTION

The present invention relates to an antimicrobial multilayer stretch wrap.

Antimicrobial features are highly desired in many products, in particular packaging of goods that are moved and shipped between places, venues, cities, countries, and continents. Such packaging is designed to stabilize loads of goods in transit from one part of the globe to another, and therefore could be a convenient base for harmful microbial infections.

Antimicrobial features may be antibacterial, anti-viral, and anti-fungal. Such antimicrobial features could be achieved by using metal compound particles.

Studies indicate that different metals cause discrete and distinct types of injuries to microbial cells as a result of oxidative stress, protein dysfunction, or membrane damage.

For the purpose of this invention, it is possible to use any one of the industrially acceptable metal compound particles as an antimicrobial agent.

Stretch wraps are widely used in various industries as packaging material. They are defined by high stretchability as well as high tear strength and tensile strength.

In this specification, the terms wrap and stretch wrap is used to describe any multilayer polymer-based plastic stretch wrap that contains at least three layers and is stretchable by at least 80% more of its post-production length.

One object of the present invention is to provide a stretch wrap with an antimicrobial character, by using the metal ion activity of particles embedded into the film.

It is another object of the present invention to provide an antimicrobial stretch wrap containing an optimal and cost-effective amount of said particles by integrating them with a proximity to the outer surface of the film.

Although prior publications teach to integrate metal compound particles in non-stretchable multilayer films, There is no solution in the art addressing the integration of metal compounds particles with heavy-duty stretch wraps, nor as a sole antimicrobial agent in other stretchable films.

The present invention discloses that placing metal compounds particles in the vicinity of the outer surface of the film could provide the antimicrobial feature without affecting the usability of the wrap and without dislocating or losing such particles in the course of stretching or later during the actual term of usage of the film.

The present invention discloses that integrating metal compound particles in the vicinity of the outer surface of a multilayer stretch wrap is useful as a long-lasting antimicrobial feature. It further discloses that stretching the film will not result in the loss or disengagement of such particles but, on the contrary, result in driving the particles toward the surface and enhance the antimicrobial effect.

Furthermore, in accordance with the present invention, the usage of the film and the elongation involved in such usage helps to bring the particles closer to the surface while keeping them intact. This is due to the stretching of the film. This stretching results in a thinner material covering the particles and even microscopic tears that are enough to reveal and enhance the ion activity of the particles yet are too small to cause disengagement thereof.

It will be emphasized that placing the metal compound particles in the outer or close to the outer layer, and the stretching of the wrap achieving a significant antimicrobial activity using a relatively small ratio of particles.

In preferred embodiments of the present invention, the multilayer stretch wrap is made by way of adding metal compound particles to the polymer granulates or pellets melted before extrusion of at least one of the external layers of the wrap.

For example, in a three layers wrap, the metal compound particles are integrated into one or both of the outer layers.

In other embodiments, where the wrap is made of five or more layers, the metal compound particles could be integrated into the second layer (No. 2 or 4 in five layers, 2 or 6 in seven layers, etc.)

It will be understood to those skilled in the art that the nature of the present invention is based on the proximity of the particles to the outer surface of the stretch wrap, in one or both sides, achieved by integrating it to an external layer or close to it combined with the application of stretching that drives the particles even closer to the surface of the wrap.

Therefore when the multilayer wrap is of significantly numerous layers, the advantages of the invention could still be achieved by integrating the metal compound particles to even inner layers. The placement of the particles in the vicinity of the surface is an advantage as long as the particles are closer to the outer surface than to the center of the wrap. For example, a 15 or a 30 layers wrap could achieve the benefit of the present invention even when placing the particles in the third or fourth layer from the outer surface. Such placement could be made, for example, when other requirements dictate the formation and compound of the outer layers, such as clarity, color strength, or others. Yet it is emphasized that the closer the particles are placed to the outer surface, the stronger is the impact of the antimicrobial effect.

It will be understood to those skilled in the art that the stretch-wrap of the present invention could be manufactured in any known method, including but not limited to cast film extrusion or blown film extrusion.

In some embodiment of the present invention, the layers consist of low-density polyethylene (LDPE) or linear low-density polyethylene (LLDPE) or metallocene linear low-density polyethylene (MLLDPE) or a medium-density polyethylene (MDPE) or a combination thereof.

In other embodiments of the present invention, the materials could be selected from any industrially acceptable polymer that could provide the desired elasticity, i.e., sufficient stretchability of at least 1.8 of the post-production length, with adequate strength of the final product.

In some embodiments of the present invention, the sub skin layer or otherwise the layer beneath the metal compound particles is made with a substance of a higher density than the one used in the integrated particles layer. This will result in further pushing the particles towards the surface upon stretching of the wrap.

In a preferred embodiment of the present invention, the metal compound particles consist of Copper Oxide (Cu₂O or CuO). Yet, in other embodiments, they comprise copper chloride (CuCl2), Copper sulfate (CuSO₄{H₂O}), as well as equivalent Zinc or Silver compounds or any combination thereof.

In some embodiment of the present invention, the metal compound particles are less than 1000 nanometers in size, preferably 500-700 nanometer.

In some embodiments of the present invention, the ratio of the metal compounds particles to the polymer of the wrap is less than 0.05% of the total mass of the wrap.

In preferred embodiments of the present invention, the ratio of the metal compounds particles to the polymer of the integrated layer is between 0.1-0.5%, of the total mass of the integrated layer.

This significantly low quantity of metal compound particles is allowed because of the main feature of the invention, related to the application of metal compound particles in a wrap that must be stretched in the course of regular use, as explained herein.

The wrap, according to the present invention, was tested for antibacterial activity and proved to be efficient with said preferred amount of particles.

It will be apparent to those skilled in the art that the present invention relates to any form of stretchable multilayer wrap including but not limited to rolled wraps, hoods, wrap films, as long as it consists of at least three layers and made in a manner that allows post-production stretch as part of its application.

Throughout this disclosure, a numerical value of a parameter, feature, characteristic, object, or dimension, may be stated or described in terms of a numerical range format. Such a numerical range format, as used herein, illustrates the implementation of some exemplary embodiments of the invention, and does not inflexibly limit the scope of the exemplary embodiments of the invention. Accordingly, a stated or described numerical range also refers to and encompasses all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention, which are illustratively described and presented in combination or sub-combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. multilayer antimicrobial stretch plastic wrap, comprising at least three layers, wherein
at least one layers comprising multiple metal compound particles integrated into said layer material, and wherein said at least one layer is not the central layer of the wrap and wherein,
said at least one layer is proximal to an outer surface of the wrap than to the center of the wrap.

2. A multilayer antimicrobial stretch plastic wrap of claim 1, wherein said at least one layer is an outer layer of said wrap.

3. A multilayer antimicrobial stretch plastic wrap of claim 1, wherein said metal compound particles are selected from copper, zinc or silver compounds, or any combination thereof.

4. A multilayer antimicrobial stretch plastic wrap of claim 1, wherein said metal compound particles are selected from copper oxide, copper sulfate or copper chloride, or any combination thereof.

5. A multilayer antimicrobial stretch plastic wrap of claim 1, wherein said metal compound particles are less than 1500 nanometer in size.

6. A multilayer antimicrobial stretch plastic wrap of claim 1, wherein said metal compound particles are in any size between 500 and 1000 nanometers in size.

7. A multilayer antimicrobial stretch plastic wrap of claim 1, wherein said metal compound particles are integrated with the polymer of said at least one layer in a ratio of less than 0.05% of the total mass of the wrap.

8. A multilayer antimicrobial stretch plastic wrap of claim 1, wherein said metal compound particles are integrated with the polymer of said at least one layer in a ratio of 0.1-0.5% of the total mass of said layer.

9. A multilayer antimicrobial stretch plastic wrap of claim 1, wherein the layer beneath each of said at least one layer is made from a higher density material.

10. A method to produce a multilayer antimicrobial stretch plastic wrap of claim 1, the method comprising the extrusion of at least three layers of polymer into a stretchable wrap, wherein
metal compound particles are integrated into the melting tank of polymer pellets, of at least one of said layers wrap, prior to the extrusion of the plastic wrap and wherein
said at least one layer is proximal to an outer surface of the wrap than to the center of the wrap.

11. The method of claim 10, wherein said at least one layer is an outer layer of said wrap.

12. The method of claim 10, wherein said metal compound particles are selected from copper, zinc or silver compounds, or any combination thereof.

13. The method of claim 10, wherein said metal compound particles are selected from copper oxide, copper sulfate or copper chloride, or any combination thereof.

14. A method of claim 1, wherein said metal compound particles are less than 1500 nanometer in size.

15. A method of claim 1, wherein said metal compound particles are in any size between 500 and 1000 nanometer in size.

16. A method of claim 1, wherein said metal compound particles are integrated with the polymer of said at least one layer in a ratio of less than 0.05% of the total mass of the wrap.

17. A multilayer antimicrobial stretch plastic wrap of claim 1, wherein said metal compound particles are integrated with the polymer of said at least one layer in a ratio of 0.1-0.5% of the total mass of said layer.

18. A multilayer antimicrobial stretch plastic wrap of claim 1, wherein the layer beneath each of said at least one layer is made from a higher density material.
